(19) United States
(12) Patent Application Publication
(10) Pub. No.: US 2026/0115701 A1
(43) Pub. Date: Apr. 30, 2026

(54) CATALYSTS, SYSTEMS, AND METHODS FOR AMMONIA SYNTHESIS

(71) Applicant: Khalifa University of Science and Technology, Abu Dhabi (AE)

(72) Inventors: Kyriaki POLYCHRONOPOULOU, Abu Dhabi (AE); Swati SINGH, Abu Dhabi (AE)

(21) Appl. No.: 19/357,320

(22) Filed: Oct. 14, 2025

Related U.S. Application Data
(60) Provisional application No. 63/713,165, filed on Oct. 29, 2024.

(51) Int. Cl. B01J 23/89; B01J 35/30; B01J 35/61; B01J 35/63; B01J 35/64; C01C 1/04

(52) U.S. Cl. CPC B01J 23/8993; B01J 23/8946; B01J 35/394; B01J 35/613; B01J 35/633; B01J 35/647; C01C 1/0411

(57) ABSTRACT

A catalyst includes a MgFeOₓ support, wherein x is a number of oxygen atoms present; ruthenium in contact with at least a portion of the MgFeOₓ support; and an additive including at least one of cobalt and molybdenum, where a weight ratio of the ruthenium to the additive ranges from about 1:5 to about 5:1.

### CROSS-REFERENCE TO RELATED APPLICATIONS

This application claims the benefit of and priority to U.S. provisional application 63/713,165, titled “RU-BASED BIMETALLIC CATALYSTS FOR AMMONIA SYNTHESIS ΔT MILD CONDITIONS”, filed Oct. 29, 2024, the contents of which are incorporated by reference herein.

### TECHNICAL FIELD

The subject matter disclosed herein relates to chemical processing and more particularly to catalysts for chemical reactions. The present disclosure further relates to methods for forming such catalysts.

### BACKGROUND

In the Haber-Bosch process, ammonia is synthesized by reacting nitrogen with hydrogen gas over a heterogeneous catalyst-most commonly a conventional iron-based catalyst was utilized-under elevated temperatures and high pressures (e.g., 100 bar to 200 bar). Conventionally, the high operating pressures and temperatures utilized in Haber-Bosch result in significant energy consumption and carbon dioxide emissions. Although lower temperatures can thermodynamically favor ammonia formation, reaction kinetics slow drastically. Therefore, these harsh conditions (elevated temperatures and high pressures) have been conventionally utilized. More recently, ruthenium-based catalysts have been utilized to promote the ammonia synthesis reaction at milder conditions. However, the market price of ruthenium has been volatile and significantly higher than iron over the past decade, rising from $1600 per kg in 2015 to a peak of $28,200 per kg, before stabilizing around $18,500 per kg in 2021. This volatility has rendered ruthenium-based catalysts prohibitively expensive, with costs estimated at $740,000 per ton in 2021, making these conventional ruthenium-based catalysts impractical for industrial ammonia synthesis. Accordingly, it is desirable to provide highly efficient and stable ruthenium-based catalysts for ammonia synthesis that can make use of ruthenium in a more cost-effective and sustainable manner.

### SUMMARY

According to one aspect, a catalyst includes a MgFeOₓ support, wherein x is a number of oxygen atoms present; ruthenium in contact with at least a portion of the MgFeOₓ support; and an additive including at least one of cobalt and molybdenum, where a weight ratio of the ruthenium to the additive ranges from about 1:5 to about 5:1.

According to another aspect, a catalyst for ammonia synthesis includes a magnesium-containing support; ruthenium in contact with at least a portion of the magnesium-containing support, wherein a weight percentage of ruthenium in the catalyst ranges from about 0.05 wt. % to about 1 wt. %; and cobalt, wherein a weight percentage of cobalt in the catalyst ranges from about 0.05 wt. % to about 1 wt. %.

According to another aspect, a method for ammonia synthesis includes introducing a nitrogen-containing feed stream to a catalyst sufficient to form ammonia at a process temperature, wherein the catalyst includes: a MgFeOₓ support, wherein x is a number of oxygen atoms present; ruthenium in contact with at least a portion of the MgFeOₓ support; and an additive including at least one of cobalt and molybdenum.

### BRIEF DESCRIPTION OF THE DRAWINGS

FIG. 1 illustrates a method for ammonia synthesis, according to some embodiments.

FIG. 2A illustrates ammonia synthesis rate of various catalysts based on pressure, according to some embodiments.

FIG. 2B illustrates a long-term stability test of various catalysts, according to some embodiments.

FIG. 3A illustrates x-ray diffraction (XRD) analysis of various catalysts and a support material, according to some embodiments.

FIG. 3B illustrates a zoomed region of the x-ray diffraction (XRD) analysis shown in FIG. 3A, according to some embodiments.

FIG. 4A illustrates N₂ adsorption-desorption isotherms for various catalysts and a support material, according to some embodiments.

FIG. 4B illustrates pore size distribution of various catalysts and a support material, according to some embodiments.

FIG. 5A illustrates Hydrogen Temperature Programmed Reduction (H₂-TPR) profiles of various catalysts and a support material, according to some embodiments.

FIG. 5B illustrates Hydrogen Temperature Programmed Reduction (H₂-TPR) profiles of various catalysts and a support material, according to some embodiments.

FIG. 6A illustrates X-ray photoelectron spectroscopy (XPS) spectra of various catalysts, according to some embodiments.

FIG. 6B illustrates X-ray photoelectron spectroscopy (XPS) spectra of various catalysts and a support material, according to some embodiments.

FIG. 6C illustrates X-ray photoelectron spectroscopy (XPS) spectra of various catalysts and a support material, according to some embodiments.

FIG. 6D illustrates X-ray photoelectron spectroscopy (XPS) spectra of various catalysts and a support material, according to some embodiments.

FIG. 7A illustrates X-ray photoelectron spectroscopy (XPS) spectra of various catalysts, according to some embodiments.

FIG. 7B illustrates X-ray photoelectron spectroscopy (XPS) spectra of various catalysts and a support material, according to some embodiments.

FIG. 7C illustrates X-ray photoelectron spectroscopy (XPS) spectra of various catalysts and a support material, according to some embodiments.

FIG. 8 illustrates a comparison of various catalysts for ammonia synthesis, according to some embodiments.

FIG. 9 illustrates x-ray diffraction (XRD) patterns for a catalyst under N₂/H₂ atmosphere at various temperatures, according to some embodiments.

FIG. 10A illustrates normalized X-ray Absorption Near Edge Structure (XANES) data collected at Fe K-edge on various catalysts, along with Fe metal as a reference, according to some embodiments.

FIG. 10B illustrates Fourier transform (magnitude and real part) of the Extended X-ray Absorption Fine Structure (EXAFS) signal collected at the Fe K-edge on various catalysts together with the fitting models, according to some embodiments.

FIG. 10C illustrates wavelet of the EXAFS signal showing the backscattering peaks as a function of the wave number, according to some embodiments.

FIG. 10D illustrates the Fourier-transformed EXAFS signal compared to a reference, according to some embodiments.

FIG. 11A illustrates XANES data collected at the Mo K-edge from a catalyst and references, according to some embodiments.

FIG. 11B illustrates the FT of k³ weighted EXAFS signal collected on catalysis samples compared to references, according to some embodiments.

FIG. 11C illustrates fitting the k³ weighted EXAFS data, according to some embodiments.

FIG. 11D illustrates corresponding FT (magnitude and real-part) collected at the Mo K-edge (20 keV) on catalysts, according to some embodiments.

FIG. 12A illustrates a Mossbauer spectrum of a catalyst, according to some embodiments.

FIG. 12B illustrates a Mossbauer spectrum of a catalyst, according to some embodiments.

FIG. 12C illustrates a Mossbauer spectrum of a catalyst, according to some embodiments.

FIG. 12D illustrates a Mossbauer spectrum of a catalyst, according to some embodiments.

FIG. 13A illustrates XPS spectra of Fe 2p for a catalyst at various temperatures under N₂/H₂ environment, according to some embodiments.

FIG. 13B illustrates XPS spectra of Fe 2p for a catalyst at various temperatures under N₂/H₂ environment, according to some embodiments.

FIG. 14A illustrates an High-Resolution Transmission Electron Microscopy (HR-TEM) image of a catalyst after in-situ reduction at 800° C. under N₂/H₂=⅓ atmosphere, according to some embodiments.

FIG. 14B illustrates an HR-TEM image of a catalyst after in-situ reduction at 800° C. under N₂/H₂=⅓ atmosphere, according to some embodiments.

### DETAILED DESCRIPTION

The present disclosure is directed to ruthenium-based catalysts for use in ammonia synthesis. Ruthenium-based catalysts have received considerable interest in ammonia (NH₃) catalysis due to superior catalytic performance. However, ruthenium is a scarce metal, and its high price inhibits its use in commercial applications. The present disclosure is directed toward the synthesis of ruthenium-based catalysts that are highly efficient and stable for ammonia synthesis. These highly efficient and stable ruthenium-based catalysts can make use of ruthenium in a cost-effective and sustainable manner.

As used herein, the terms “catalyst”, “catalytic material”, or the like can refer to material which enables a chemical reaction to proceed at a faster rate or under different conditions (e.g., at a lower temperature) than otherwise possible, or to control a chemical reaction to generate particularly desired products. The catalysts of the present disclosure may include mixtures of two or more catalytic material(s) with other inert materials. The catalytic materials used in the present disclosure may be formed into desired shapes or sizes. The catalytic materials of the present disclosure can be pre-reduced catalyst precursors.

The catalyst includes one or more catalytically active materials and a support. The catalytically active material at least partially facilitates the chemical reaction and provides the active sites where reactants are adsorbed, transformed, and/or desorbed. The catalytically active material can include one or more catalytically active metals capable of promoting ammonia synthesis.

The catalytically active material includes ruthenium metal. The systems and methods disclosed herein result in high dispersion of Ru on and/or within the support, which in turn provides more active sites for catalytic activity. In one example, the amount of ruthenium present in the catalyst is greater than 0.01 weight percent (wt. %). In another example, the amount of ruthenium present in the catalyst is greater than 0.05 wt. %. In another example, the amount of ruthenium present in the catalyst is less than 5 wt. %. In another example, the amount of ruthenium present in the catalyst is less than 2 wt. %. In another example, the amount of ruthenium present in the catalyst is less than 1 wt. %. Weight percentages can be determined by elemental analysis, such as EDS (Energy Dispersive X-ray Spectroscopy) analysis.

In one example, the amount of ruthenium present in the catalyst is between about 0.05 and about 1.0 wt. %, in another example between about 0.05 and about 0.7 wt. %, in another example between about 0.05 and about 0.3 wt. %, and in another example between about 0.01 and about 0.7 wt. %. In one example, the weight percentage of ruthenium in the catalyst is about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. % or about 1.0 wt. %, or values or ranges therebetween. In one example, an amount of ruthenium present in the catalyst ranges from about 0.05 wt. % to about 0.2 wt. %. In one example, an amount of ruthenium present in the catalyst ranges from about 0.07 wt. % to about 0.15 wt. %.

The catalyst (e.g., catalytically active material of the catalyst) can include at least one additive, such as cobalt and/or molybdenum. In one example, the weight ratio of ruthenium to the additive ranges from about 1:5 to about 5:1. In another example, the weight ratio of ruthenium to the additive ranges from about 1:3 to about 3:1. In another example, the weight ratio of ruthenium to the additive ranges from about 1:2 to about 2:1. In another example, the weight ratio of ruthenium to the additive ranges from about 1:1.5 to about 1.5:1. In another example, the weight ratio of ruthenium to the additive is about 1:1.

In one example, the additive includes cobalt. In one example, the amount of cobalt present in the catalyst is greater than 0.01 wt. %. In another example, the amount of cobalt present in the catalyst is greater than 0.05 wt. %. In another example, the amount of cobalt present in the catalyst is less than 5 wt. %. In another example, the amount of cobalt present in the catalyst is less than 2 wt. %. In another example, the amount of cobalt present in the catalyst is less than 1 wt. %.

In one example, the amount of cobalt present in the catalyst is between about 0.05 and about 2.0 wt. %, in another example between about 0.01 and about 0.7 wt. %, in another example between about 0.05 and about 1 wt. %, and in another example between about 0.01 and about 0.5 wt. %. In another example, the amount of cobalt ranges from about 0.05 wt. % to about 2 wt. %, from about 0.05 to about 1 wt. %, or from about 0.05 wt. % to about 0.3 wt. %. In one example, the weight percentage of cobalt in the catalyst is about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. % or about 1.0 wt. %, or values or ranges therebetween. In one example, an amount of cobalt present in the catalyst ranges from about 0.07 wt. % to about 0.15 wt. %.

The catalyst (e.g., catalytically active material of the catalyst) can include ruthenium and cobalt. The addition of cobalt can reduce the amount of ruthenium used while maintaining or improving conversion efficiency. In one non-limiting example, compared to monometallic catalysts, the catalysts including ruthenium and cobalt exhibit higher ammonia yields in ammonia synthesis. This difference in catalytic activity can be attributed to the incorporation of ruthenium into the catalyst, forming a bimetallic Ru—Co system. The electron-rich Ru active sites on the RuCo surface, facilitated by Co-induced spin-symmetry breaking, can contribute to stronger binding of N₂ intermediates during the NH₃ synthesis process. This enhanced binding can improve catalytic performance in terms of reaction kinetics and thermodynamics, resulting in higher ammonia synthesis rates. Accordingly, using the combination of ruthenium and cobalt in the catalyst can create a synergistic effect.

In one example, the weight ratio of ruthenium to cobalt ranges from about 1:3 to about 3:1. In another example, the weight ratio of ruthenium to cobalt ranges from about 1:2 to about 2:1. In another example, the weight ratio of ruthenium to cobalt ranges from about 1:1.5 to about 1.5:1. In another example, the weight ratio of ruthenium to cobalt is about 1:1.

In one example, the catalyst (e.g., catalytically active material of the catalyst) includes molybdenum. In one example, the amount of molybdenum present in the catalyst is greater than 0.01 wt. %. In another example, the amount of molybdenum present in the catalyst is greater than 0.05 wt. %. In another example, the amount of molybdenum present in the catalyst is less than 5 wt. %. In another example, the amount of molybdenum present in the catalyst is less than 2 wt. %. In another example, the amount of molybdenum present in the catalyst is less than 1 wt. %.

In one example, the amount of molybdenum present in the catalyst is between about 0.01 and about 1.0 wt. %, in another example between about 0.05 and about 1 wt. %, in another example between about 0.01 and about 0.3 wt. %, and in another example between about 0.05 and about 0.5 wt. %. In another example, the amount of molybdenum ranges from about 0.05 wt. % to about 2 wt. %, from about 0.05 to about 1 wt. %, or from about 0.05 wt. % to about 0.3 wt. %. In one example, the weight percentage of molybdenum in the catalyst is about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. % or about 1.0 wt. %. In one example, an amount of molybdenum present in the catalyst ranges from about 0.07 wt. % to about 0.15 wt. %.

The catalyst (e.g., catalytically active material of the catalyst) can include ruthenium and molybdenum. The addition of molybdenum can reduce the amount of ruthenium used while maintaining or improving conversion efficiency. In one example, the weight ratio of ruthenium to molybdenum ranges from about 1:3 to about 3:1. In another example, the weight ratio of ruthenium to molybdenum ranges from about 1:2 to about 2:1. In another example, the weight ratio of ruthenium to molybdenum ranges from about 1:1.5 to about 1.5:1. In another example, the weight ratio of ruthenium to molybdenum is about 1:1.

The catalytically active material and/or additive are generally in contact with at least a portion of the support. The catalytically active material and/or additive can be dispersed on/within a support. The support can improve dispersion of the catalytically active material and enhance the catalytic properties of the active metal. Surface area, pore structure, and the presence of specific sites (e.g., oxygen vacancies) on the support can be tuned to promote efficient performance during operation of the methanation reaction. The support can be formed into predetermined shapes. For example, the support can take the form of spherical particles or beads, porous beads, pellets, tubes, Raschig rings, Super Raschig rings, Pall rings, Bielecki rings, extrudates, lobes, and/or saddles.

The support includes at least one of magnesium, iron, and oxides thereof. In one example, the support is a magnesium-containing support. For example, the magnesium-containing support can follow the formula: MgFeOₓ, where x is the number of oxygen atoms present. In one example, x is equal to 4. In one example, the magnesium-containing support includes MgFeOₓ, and the Mg to Fe ratio is between about 2:1 and about 3:1 (atomic ratio). In another example, the magnesium-containing support includes MgFeOₓ, and the Mg to Fe ratio is about 2:1. In another example, the magnesium-containing support includes MgFeOₓ, and the Mg to Fe ratio is about 2.1:1, about 2.2:1, about 2.3:1, about 2.4:1, about 2.5:1, about 2.6:1, about 2.7:1, about 2.8:1, about 2.9:1 or about 3.0:1. In another example, the iron and ruthenium are closely associated with each other in the form of an alloy.

The MgFeOₓ support can be prepared from MgFe layered double hydroxide (LDH). MgFe layered double hydroxide (LDH) is a clay (e.g., synthetic and anionic) including layers of magnesium and iron hydroxides with intercalated anions and water molecules. For example, a MgFE LDH powder can be calcined to form the MgFeOₓ support. The MgFe LDH structure is calcined, and the result is an MgFeO_{4-δ}[δ=+0.1] spinel structure. The δ value depends upon the O vacancy created in the structure during the calcination, which can exhibit a slight variation-hence the & range provided herein.

The weight percentage of the support in the catalyst can be greater than 70 wt. %, greater than 80 wt. %, greater than 90 wt. %, or values therebetween. The weight percentage of the support in the catalyst can be less than 99.9 wt. %, less than 99 wt. %, or values therebetween. The weight percentage of the support in the catalyst can range from 90 wt. % to 99.9 wt. %. In one example, the wight percentage of the support in the catalyst ranges from 95 wt. % to 99.9 wt. %. In another example, the weight percentage of the support in the catalyst ranges from 97 wt. % to 99.8 wt. %.

The support can exhibit an average pore size (e.g., diameter) ranging from about 20 nm to about 70 nm. In one example, the support exhibits an average pore size ranging from about 30 nm to about 60 nm. In one example, the support exhibits an average pore size ranging from about 40 nm to about 50 nm. The catalyst can exhibit an average pore size ranging from about 15 nm to about 45 nm. In one example, the catalyst exhibits an average pore size ranging from about 20 nm to about 38 nm. Average pore size can be determined using mercury intrusion porosimetry, where mercury is forced into pores under controlled pressure, and the applied pressure is related to pore size.

The support can exhibit a BET (Brunauer-Emmett-Teller) surface area of greater than about 30 m²/g. In one example, the support exhibits a BET surface area of greater than about 40 m²/g. In another example, the support exhibits a BET surface area ranging from about 30 m²/g to about 80 m²/g. The catalyst can exhibit a BET surface area of greater than about 20 m²/g. In one example, the catalyst exhibits a BET surface area of greater than about 25 m²/g. In another example, the catalyst exhibits a BET surface area ranging from about 25 m²/g to 35 m²/g. In one example, the catalyst exhibits an average pore size ranging from about 20 nm to about 40 nm, a pore volume ranging from about 0.1 cm³/g to about 0.4 cm³/g, and a surface area ranging from 20 m²/g to 50 m²/g. The BET surface area can be determined based on how much gas, such as nitrogen, is adsorbed onto a surface of the catalyst/support.

Embodiments of the present disclosure describe a method of making a ruthenium-based catalyst, including calcining a MgFe LDH powder to form a MgFeOₓ support. This is followed by loading catalytically active material on the MgFeOₓ support and reducing the loaded support to form the catalyst. In one example, the catalyst follows the formula: MgFeOₓ—RuCo, where x is about 4. In one example, the catalyst follows the formula: MgFeOₓ-0.2RuCo, where x is about 4, and 0.2 corresponds to 0.2 wt. % of both ruthenium and cobalt (0.1 wt. % of each). In another example, the catalyst follows the formula: MgFeOₓ—RuMo, where x is about 4. In another example, the catalyst follows the formula: MgFeOₓ-0.2RuMo, where x is about 4, and 0.2 corresponds to 0.2 wt. % of both ruthenium and molybdenum (0.1 wt. % of each).

The method of making the catalyst can include preparing MgFe LDH powder and calcining the powder at a temperature sufficient to form a support. Alternatively, the method can include obtaining the MgFe LDH powder. The powder can be calcined at 600° C. for 5 hours with a heating rate of 10° C./min to obtain the support (MgFeOₓ). For some embodiments of the present disclosure, the powder is calcined at a temperature range of about 550° C. to about 650° C. For yet other embodiments of the present disclosure, the powder is calcined at a temperature range of about 575° C. to about 625° C. In some embodiments, the temperature is about 600° C. For some embodiments of the present disclosure, the powder is calcined for a period of about 3 to about 7 hours. For some embodiments of the present disclosure, the powder is calcined for a period of about 4 to about 9 hours. In some embodiments, the time for calcining is about 5 hours. The catalytically active material can then be loaded on the support using a loading technique, such as wet impregnation.

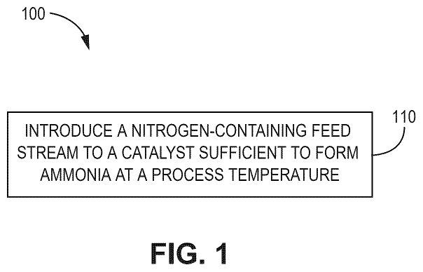

FIG. 1 illustrates a method for ammonia synthesis, according to some embodiments. Method 100 includes one or more of the following aspects:

A feed stream (e.g., nitrogen-containing feed stream) is introduced 110 to a catalyst sufficient to form ammonia at a process temperature. Introducing 110 includes bringing one or more chemical species (reactant(s) in feed stream) into contact with the catalyst (e.g., by passing over the catalyst) in such a way that they can interact (physically/chemically) and undergo a catalytic transformation to one or more products. The nitrogen-containing feed stream includes nitrogen gas. The nitrogen-containing feed stream can further include at least one of hydrogen gas, water, and natural gas. In one example, both nitrogen gas and hydrogen gas are introduced 110 as a single feed stream. In another example, nitrogen gas and hydrogen as are introduced 110 as separate feed streams. The catalyst includes a catalyst of the present disclosure.

The process temperature can be a temperature of greater than 200° C. In one example, the process temperature is a temperature of greater than 250° C. In another example, the process temperature is a temperature of greater than 300° C. In another example, the process temperature is a temperature of greater than 350° C. In another example, the process temperature is a temperature ranging from 300° C. to 800° C. In another example, the process temperature is a temperature ranging from 300° C. to 600° C. In another example, the process temperature is a temperature ranging from 350° C. to 450° C.

The feed stream can be introduced 110 at a process pressure of greater than 10 bar. The feed stream can be introduced 110 at a process pressure of greater than 20 bar. In one example, the feed stream can be introduced 110 at a process pressure ranging from about 5 bar to about 100 bar. In one example, the feed stream can be introduced 110 at a process pressure ranging from about 30 bar to about 150 bar. In another example, the feed stream can be introduced 110 at a process pressure ranging from about 40 bar to about 60 bar.

The feed stream can be introduced 110 at a gas hourly space velocity (ratio of the volumetric gas flow rate to the catalyst volume) of greater than 10,000 h⁻¹. The feed stream can be introduced 110 at a gas hourly space velocity ranging from 5,000 h⁻¹ to 100,000 h⁻¹. In one example, the feed stream is introduced 110 at a gas hourly space velocity ranging from 10,000 h⁻¹ to 50,000 h⁻¹.

Introducing 110 the nitrogen-containing feed stream to the catalyst is sufficient to form ammonia at the process temperature. The ammonia yield can be greater than 3000 μmol g_{cat}⁻¹h⁻¹. In one example, the ammonia yield is greater than 5000 μmol g_{cat}⁻¹h⁻¹. In another example, the ammonia yield is greater than 7000 μmol g_{cat}⁻¹h⁻¹. The ratio of the ammonia yield to weight percentage of ruthenium in the catalyst can be greater than 30,000. The ratio of the ammonia yield to weight percentage of ruthenium in the catalyst can be greater than 40,000.

Accordingly, the present disclosure is directed toward the synthesis of ruthenium-based catalysts that are highly efficient and stable for ammonia synthesis. These highly efficient and stable ruthenium-based catalysts can make use of ruthenium in a cost-effective and sustainable manner. In one non-limiting example, by utilizing ruthenium and an additive such as cobalt and/or molybdenum, catalysts of the present disclosure can utilize less ruthenium compared to comparison catalysts, while exhibiting excellent efficiency for ammonia synthesis. By utilizing less ruthenium, the catalysts can be produced in a more cost-effective manner.

### Example 1

MgFe LDH was formed. The obtained powder was then calcined at 600° C. for 5 hours with a heating rate of 10° C./min to obtain the support (MgFeOₓ). Further, a chemical reduction method, using sodium borohydride as the reducing agent, was used to synthesize bimetallic catalysts based on Ru, incorporating a) Ru and Co and b) Ru and Mo into/on a MgFeOₓ support. The catalysts were examined using various characterization methods to investigate physical and chemical attributes. These techniques included X-ray diffraction (XRD), N₂-adsorption, High-Resolution Transmission Electron Microscopy (HR-TEM), H₂ Temperature-programmed Reduction (TPR), and X-ray photoelectron spectroscopy (XPS).

“MgFeOₓ-0.2Co” refers to a comparison catalyst including cobalt and a MgFeOₓ support, where the weight percentage of cobalt in the catalyst is Co=0.2 wt. %. As used in the examples for the present catalyst, MgFeOₓ is a MgFeO_{4-δ}[δ=10.1] spinel structure.

“MgFeOₓ-0.2Co—Ru” refers to a bimetallic catalyst including cobalt, ruthenium, and a MgFeOₓ support, where the wt. % of Ru═Co=0.1 wt. %. As used in the examples for the present catalyst, MgFeOₓ is a MgFeO_{4-δ}[δ=+0.1] spinel structure.

“MgFeOₓ-0.2Mo” refers to a comparison catalyst including molybdenum and a MgFeOₓ support, where the weight percentage of molybdenum in the catalyst is Mo=0.2 wt. %. As used in the examples for the present catalyst, MgFeOₓ is a MgFeO_{4-δ}[δ=+0.1] spinel structure.

“MgFeOₓ-0.2Mo—Ru” refers to a bimetallic catalyst including molybdenum, ruthenium, and a MgFeOₓ support, where the wt. % of Ru═Mo=0.1 wt. %. As used in the examples for the present catalyst, MgFeOₓ is a MgFeO_{4-δ}[δ=±0.1] spinel structure.

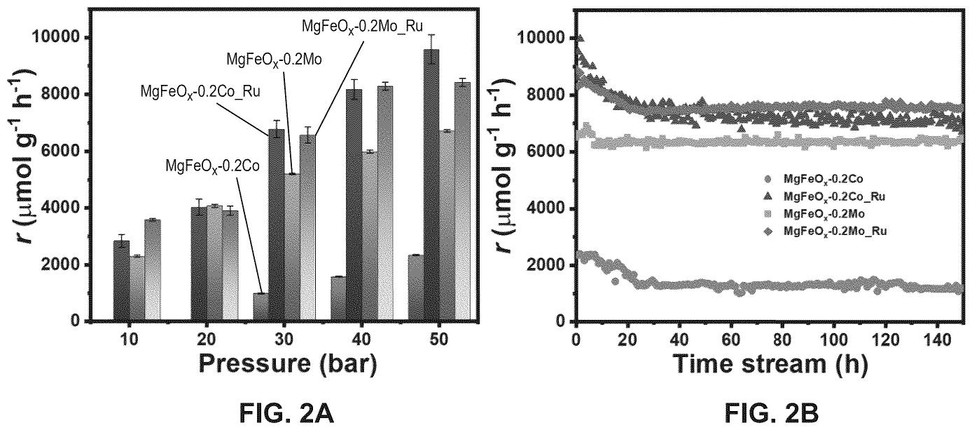

FIG. 2A illustrates ammonia synthesis rate of various catalysts based on pressure, according to some embodiments. To examine the effect of pressure ranging from 10 to 50 bar, as observed in FIG. 2A, the catalysts improved in NH₃ synthesis activity with increasing pressure. At a constant temperature of 450° C. and different pressures of 10, 20, 30, 40 and 50 bar, an increase of NH₃ production was seen with the pressure; for example, NH₃ rates at 50 bar were measured experimentally as 2342.1, 9583.6, 6709.8, and 8416 μmol g⁻¹h⁻¹, for MgFeOₓ-0.2Co, MgFeOₓ-0.2Co—Ru, MgFeOₓ-0.2Mo, and MgFeOₓ-0.2Mo—Ru, respectively. In one example, at the operating conditions of 50 bar and 450° C., the catalyst performance exhibited a distinct trend as follows: MgFeOₓ-0.2Co—Ru (9583.6 μmolg⁻¹ h⁻¹)>MgFeOₓ-0.2Mo—Ru (8416.0 μmolg⁻¹ h⁻¹)>MgFeOₓ-0.2Mo (6709.8 μmolg⁻¹ h⁻¹)>MgFeOₓ-0.2Co (2342.1 μmolg⁻¹ h⁻¹).

FIG. 2B illustrates a long-term stability test of various catalysts, according to some embodiments. A stability assessment was carried out for the catalysts to enhance the efficiency and dependability of NH₃ production processes while reducing expenses. The examination occurred at a temperature of 400° C., with a weight hourly space velocity (WHSV) of 10,000 mLg⁻¹ h⁻¹ and at a pressure of 50 bar. FIG. 2B shows the stability of the catalysts for a prolonged duration of 150 h. The bimetallic catalysts maintained higher NH₃ synthesis rates than monometallic catalysts and, after a certain duration, maintained a stable activity. For example, MgFeOₓ-0.2Mo—Ru showed higher activity for a longer duration. In conclusion, for prolonged time on stream, the catalyst performance exhibited a trend as follows: MgFeOₓ-0.2Mo—Ru (7542.2 μmolg⁻¹ h⁻¹)>MgFeOₓ-0.2Co—Ru (6704.1 μmolg⁻¹ h⁻¹)>MgFeOₓ-0.2Mo (6490.2 μmolg⁻¹ h⁻¹)>MgFeOₓ-0.2Co (1186.5 μmolg⁻¹ h⁻¹).

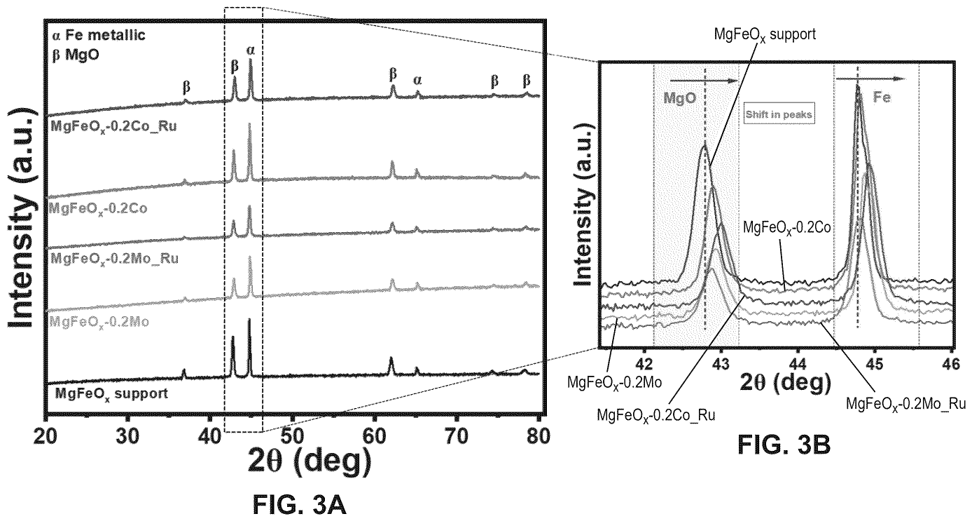

FIG. 3A illustrates x-ray diffraction (XRD) analysis of various catalysts and a support material, according to some embodiments. FIG. 3A presents the comprehensive XRD plot of the reduced bimetallic catalysts (H₂ reduction at 800° C. for 1 h), the comparison monometallic catalysts, and a MgFeOₓ support. Both the support and catalysts exhibit MgO and metallic Fe phases after the reduction. The MgFeOₓ spinel phase in the support was reduced to MgO and metallic Fe phases.

FIG. 3B illustrates a zoomed region of the x-ray diffraction (XRD) analysis shown in FIG. 3A, according to some embodiments. In FIG. 3B, the catalysts exhibit shifts toward higher 2θ values in the peaks of both MgO (2θ=42.7°) and metallic Fe (2θ=44.7°) phases, compared to that of support. The observed shift in the 2θ value of the catalysts shows a decrease in the d-spacing value, which can be attributed to the interactions involving the presence of metal in the catalysts.

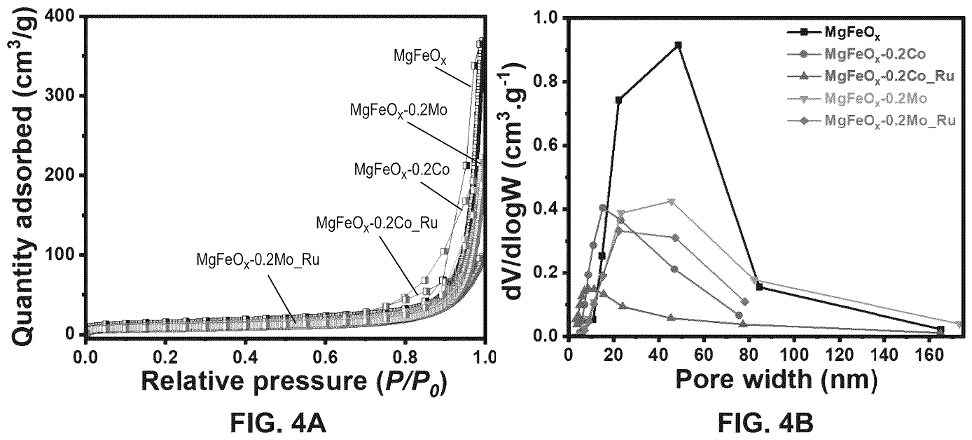

FIG. 4A illustrates N₂ adsorption-desorption isotherms for various catalysts and a support material, according to some embodiments. For example, the MgFeOₓ support, bimetallic catalysts (MgFeOₓ-0.2Co—Ru, MgFeOₓ-0.2Mo—Ru), and the comparison monometallic catalysts (MgFeOₓ-0.2Co and MgFeOₓ-0.2Co), exhibited a Type IV isotherm, showing the presence of mesoporous characteristics. FIG. 4B illustrates pore size distribution of various catalysts and a support material, according to some embodiments. Table 1 summarizes the properties of a series of catalysts, focusing on the surface area, pore volume, and pore diameter. The MgFe LDH material is characterized by a high surface area (88 m²/g), a pore volume of 0.2 cm³/g, and pore diameters of 11 nm. In contrast, MgFeOₓ exhibits a reduced surface area (50 m²/g) with larger pore volume (0.6 cm³/g) and broader pore diameters (45 nm), positioning it favorably for accommodating larger molecular species.

TABLE 1
Catalyst and Support Surface Area,
Pore Volume, and Pore Diameter.

| | Surface area | Pore volume | Pore diameter |
|---|---|---|---|
| Catalysts | (m²/g) | (cm³/g) | (nm) |
| MgFe LDH | 88 | 0.2 | 11 |
| MgFeOₓ | 50 | 0.6 | 45 |
| MgFeOₓ—0.2Co | 40 | 0.33 | 33 |
| MgFeOₓ—0.2Co_Ru | 27 | 0.15 | 22 |
| MgFeOₓ—0.2Mo | 33 | 0.34 | 40 |
| MgFeOₓ—0.2Mo_Ru | 33 | 0.29 | 34 |

The comparison of data between the MgFeOₓ support, the monometallic MgFeOₓ-0.2Mo, and bimetallic MgFeOₓ-0.2Mo_Ru catalysts also reveals significant alterations in structural characteristics. The introduction of Mo to form the MgFeOₓ-0.2Mo catalyst also results in a reduction in surface area (33 m²/g) and pore volume (0.34 cm³/g), coupled with a minor shift in pore diameters (40 nm). Similarly, MgFeOₓ-0.2Mo_Ru, which incorporates both Mo and Ru, exhibits lower surface area, reduced pore volume (0.29 cm³/g), and a slight shift in pore diameters (34 nm). Overall, the reduction in surface area, as seen in Table 1, can be attributed to the increased dispersion of the active metal Co, Mo and Ru in the catalyst. In one example, the pore size distribution (FIG. 4B) analysis revealed that the majority of the pores in the catalysts were in the range of 30-40 nm.

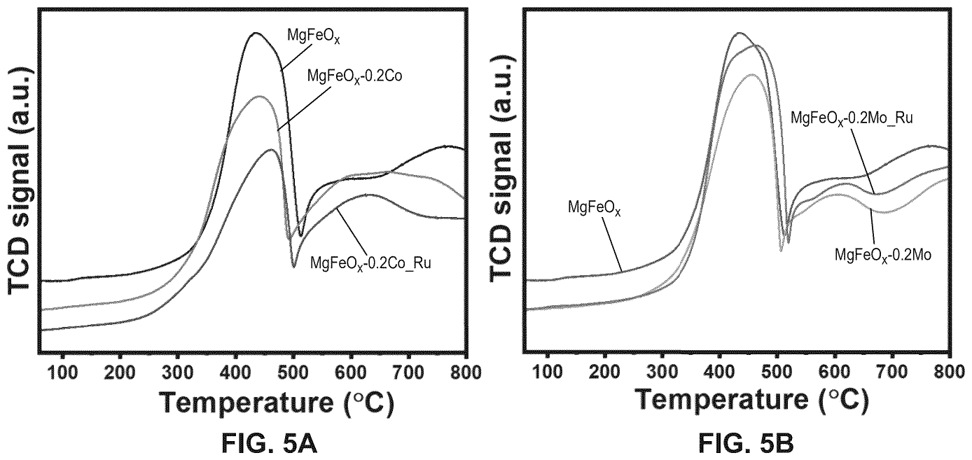

FIG. 5A illustrates Hydrogen Temperature Programmed Reduction (H₂-TPR) profiles of various catalysts and a support material, according to some embodiments. The reduction behavior of the MgFeOₓ support and catalysts exhibited distinctive patterns characterized by three distinct reduction peaks. The reduction of the MgFe₂O₄ support to metallic Fe, involving the transformation of Fe³⁺ to Fe²⁺ and further to Fe⁰, occurred within the temperature range of 480-800° C. Particularly, introducing Co to MgFeOₓ led to a shift in the first reduction peak to higher temperatures (FIG. 5A). Moreover, incorporating both Co and Ru further elevated the reduction temperature. Cobalt oxide reduction occurs in two steps in a temperature range of 250-500° C., involving the transformation of Co₃O₄→CoO→Co.

FIG. 5B illustrates Hydrogen Temperature Programmed Reduction (H₂-TPR) profiles of various catalysts and a support material, according to some embodiments. In the case of Mo and Mo—Ru-based catalysts, a shift to higher reduction temperatures was observed, primarily affecting the first reduction step, which occurred in the temperature range of 400-500° C. (FIG. 5B). Moreover, the reduction of Mo within the catalyst reveals a distinctive bimodal peak pattern. This includes a low-temperature peak, spanning 260-510° C., which has been attributed to the reduction of Mo⁶⁺ species to Mo⁴⁺, and a high-temperature peak ranging from 530-920° C., associated with the reduction of Mo⁴⁺ to Mo⁰. In one example, the collective impact of metal incorporation is evident through the observed shift towards higher reduction temperatures, signifying the influence of Mo and Ru, emphasizing its role in the altered reduction dynamics of the catalyst.

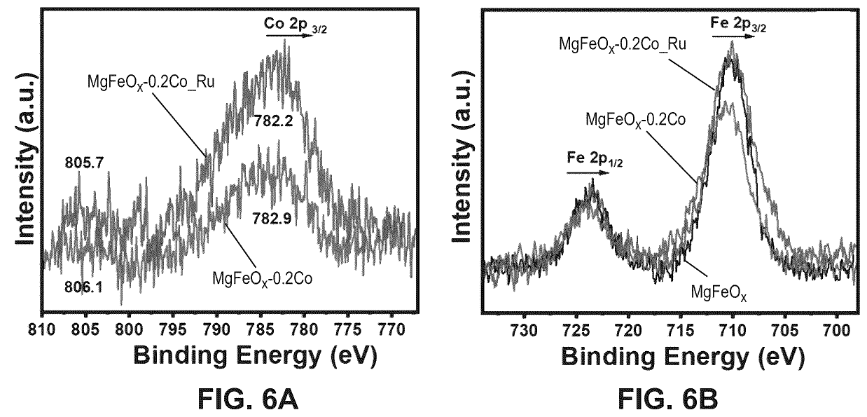

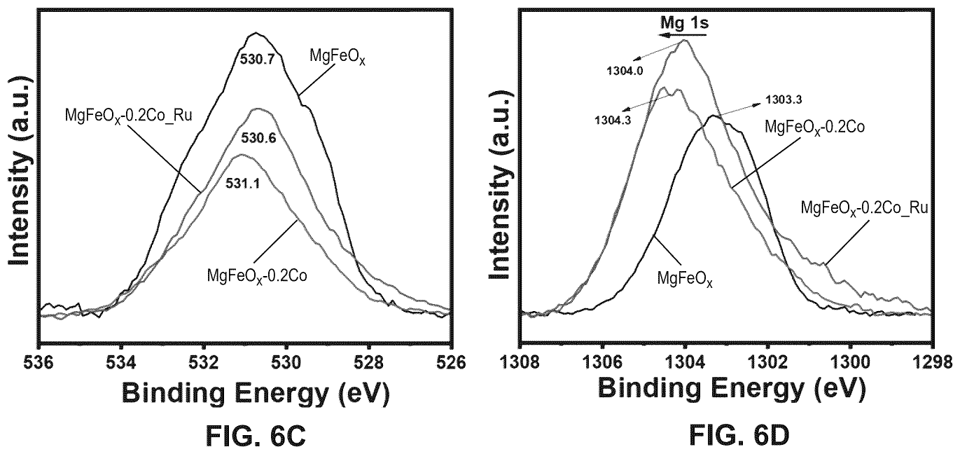

FIG. 6A illustrates X-ray photoelectron spectroscopy (XPS) spectra of various catalysts, according to some embodiments. FIG. 6B illustrates X-ray photoelectron spectroscopy (XPS) spectra of various catalysts and a support material, according to some embodiments. FIG. 6C illustrates X-ray photoelectron spectroscopy (XPS) spectra of various catalysts and a support material, according to some embodiments. FIG. 6D illustrates X-ray photoelectron spectroscopy (XPS) spectra of various catalysts and a support material, according to some embodiments.

XPS analysis compared monometallic MgFeOₓ-0.2Co and bimetallic MgFeOₓ-0.2Co_Ru catalysts with the MgFeOₓ support. In the XPS spectra (FIG. 6A) regarding Co 2p_{3/2} of MgFeOₓ-0.2Co_Ru, the peaks at 782.9 eV are related to Co(II), which was shifted to lower BE value for MgFeOₓ-0.2Co_Ru (782.2 eV). FIG. 6B shows a Fe 2p spectrum including peaks of Fe 2p_{3/2} (710±0.1) eV and Fe 2p_{1/2} (723±0.1) eV in octahedral Fe³⁺ ions. With metal incorporation, MgFeOₓ-0.2Co showed a higher BE compared to the support, while MgFeOₓ-0.2Co_Ru exhibited a similar BE to the support. O 1s showed a higher BE shift in MgFeOₓ-0.2Co but a lower BE shift in MgFeOₓ-0.2Co_Ru compared to MgFeOₓ. Both MgFeOₓ-0.2Co and MgFeOₓ-0.2Co_Ru demonstrated higher BE values for Mg 1s than the MgFeOₓ support. (FIG. 6D)

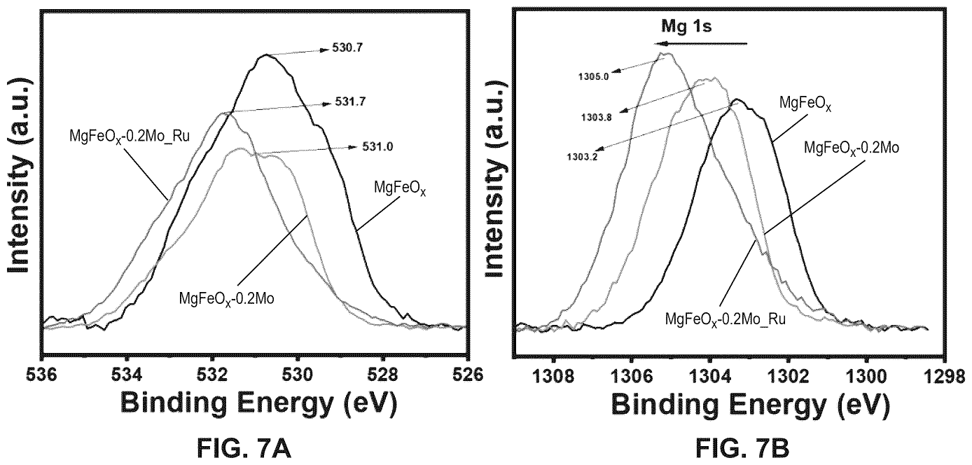

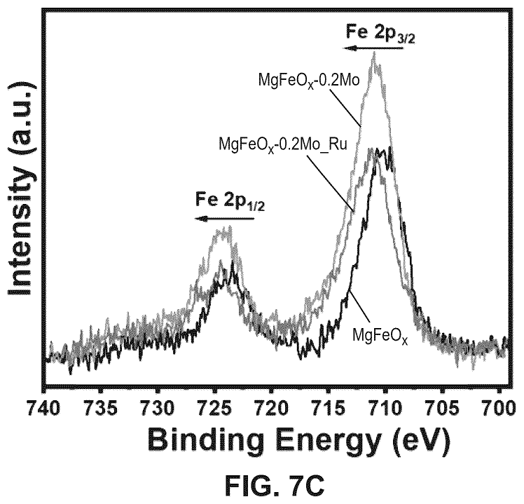

FIG. 7A illustrates X-ray photoelectron spectroscopy (XPS) spectra of various catalysts, according to some embodiments. FIG. 7B illustrates X-ray photoelectron spectroscopy (XPS) spectra of various catalysts and a support material, according to some embodiments. FIG. 7C illustrates X-ray photoelectron spectroscopy (XPS) spectra of various catalysts and a support material, according to some embodiments. Slight shifts to higher BE were observed in the Fe 2p spectra compared to the support. However, significant BE shifts were noted for both O 1s and Mg 1s catalysts, with bimetallic MgFeOₓ-0.2Mo_Ru showing a more pronounced shift to higher BE than monometallic MgFeOₓ-0.2Mo.

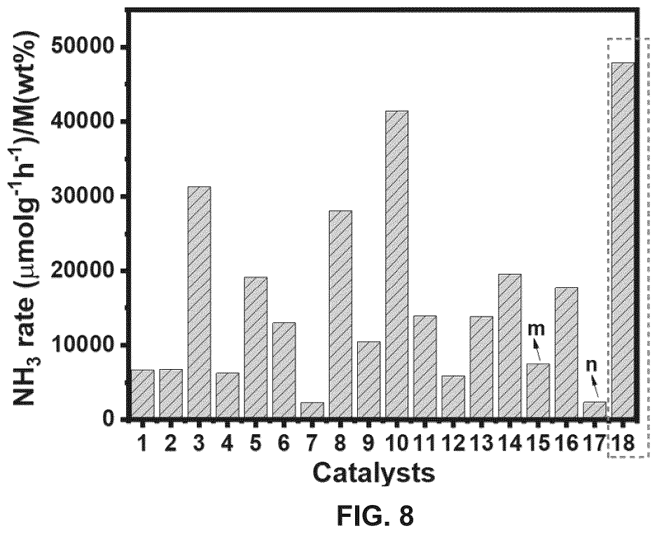

FIG. 8 illustrates a comparison of various catalysts for ammonia synthesis, according to some embodiments. Table 2 summarizes the catalytic performance of NH₃ synthesis using comparison Ru- and Fe-based catalysts and a catalyst of the present disclosure. The NH₃ synthesis rates of the catalysts were normalized with respect to the weight percentage of Ru added in each case. The MgFeOₓ-0.2Ru_Co normalized NH₃ synthesis rate was significantly higher than the comparison values, showing the performance of the Ru—Co-based bimetallic catalyst formulation. The MgFeOₓ-0.2Ru_Co catalyst also demonstrated excellent stability over a 150-hour test, which has significant industrial benefits. The extended strength reduces downtime for catalyst replacement, increases overall productivity, and leads to cost savings in NH₃ production processes.

TABLE 2
Catalyst Comparison.

| | | | | | NH₃ | NH₃ |
|---|---|---|---|---|---|---|
| | | Ru | Temperature | Pressure | yield (μmol | yield/Ru |
| No. | Catalyst | (wt. %) | (° C.) | (Bar) | g_{cat}⁻¹h⁻¹) | (wt. %) |
| 1 | Ru/ | 4.5 | 400 | 9 | 30 000 | 6666 |
| | BaCeO₃—ₓN_{y}H_{z} | | | | | |
| 2 | LaN—Ru/ZrH₂ | 2.0 | 350 | 10 | 12800 | 6400 |
| 3 | Ru/BaTiO_{2.5}H_{0.5} | 0.9 | 400 | 50 | 28 200 | 31333 |
| 4 | Ru/La_{0.5}Ce_{0.5}O_{1.75} | 5.0 | 350 | 10 | 31 300 | 6260 |
| 5 | Ru/BaCeO₃ | 1.25 | 400 | 1 | 24 000 | 19200 |
| 6 | Ru/Sm₂O₃ | 5.0 | 400 | 10 | 64 852 | 12970 |
| 7 | Ru/Ba—Ca(NH₂)₂ | 10.0 | 300 | 9 | 23 300 | 2330 |
| 8 | Ba/Ce/Ru ACCs | 2.0 | 400 | 10 | 56 160 | 28080 |
| 9 | Ru/Ba/LaCeOx | 5.0 | 350 | 10 | 52 300 | 10460 |
| 10 | Ba—Ru/BN | 4.5 | 400 | 100 | 186 600 | 41466 |
| 11 | Cs—Ru/G1900/OR | 17.6 | 430 | 100 | ca. 245 535 | 13950 |
| 12 | K—Ru/G1900/OR | 17.6 | 430 | 100 | ca. 103 571 | 5884 |
| 13 | Ba—Ru/G1900/OR | 17.2 | 430 | 100 | ca. 238 314 | 13855 |
| 14 | K—Ba—Cs—Ru/G1900 | 11.8 | 430 | 100 | ca. 230 911 | 19568 |
| 15 | Ba—Cs—Ru/C | 9.1 | 400 | 90 | 68 500 | 7527 |
| 16 | Ba—Ru—K/AC | 4.0 | 350 | 100 | 70 800 | 17700 |
| 17 | Mittasch's Fe | 40.5 | 460 | 150 | 95 600 | 2360 |
| 18 | MgFeOₓ—0.2Ru_Co | 0.2 | 400 | 50 | 7542.2 | 47918 |

### Example 2

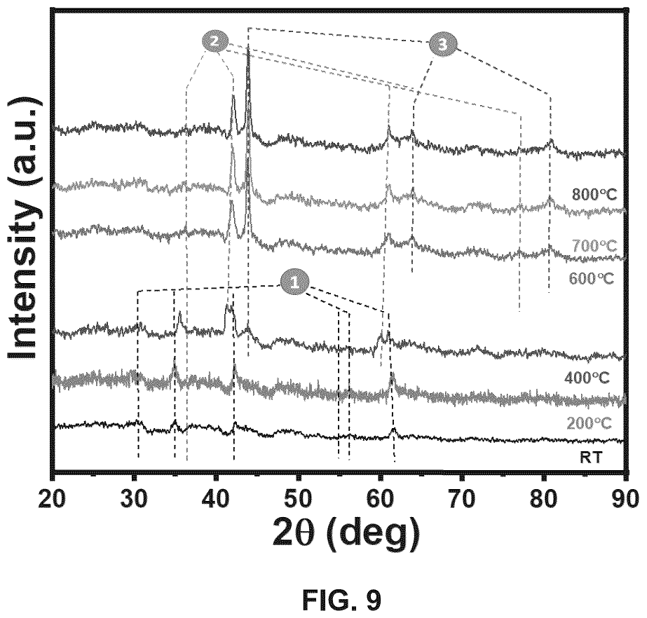

FIG. 9 illustrates x-ray diffraction (XRD) patterns for a catalyst under N₂/H₂ atmosphere at various temperatures, according to some embodiments. XRD of MgFeOₓ-0.2Co—Ru was performed at room temperature (RT) without reduction environment followed by increasing temperature from 200 to 800° C. under N₂/H₂, over the bimetallic catalysts MgFeOₓ-0.2Co_Ru. The in-situ XRD analysis of MgFeOₓ-0.2Co_Ru catalyst under N₂/H₂ atmosphere revealed a progressive phase transformation as temperature is increasing. In one example, at RT, diffraction peaks corresponding to MgFeCoO₄/MgO were observed, indicative of the initial spinel phase. In one example, as the temperature increased, a gradual emergence of Mg(Fe,Co) O wüstite-like phase was detected, with the transformation beginning at approximately 400° C.

After the temperature reached 600° C., an emergence of the FeCo-bcc phase was observed. This observation demonstrates the thermal reduction of MgFe₂O₄, where Fe³⁺ undergoes stepwise reduction (Fe³→Fe²⁺→Fe⁰) as temperature rises in a reducing atmosphere. As the temperature reached 700° C., the diffraction peaks of the FeCo phase became sharper and more intense, showing an improvement in the alloy crystallinity due to enhanced atomic diffusion and grain growth. In one example, overall, the in-situ XRD results show that the reduced MgFeOₓ-0.2Co—Ru catalysts included a single metallic/alloy phase, which corresponds to α-Fe, bcc FeCo alloy, together with an oxidic wüstite-like Mg(Fe, Co) O phase, which still contains some transition metal cations.

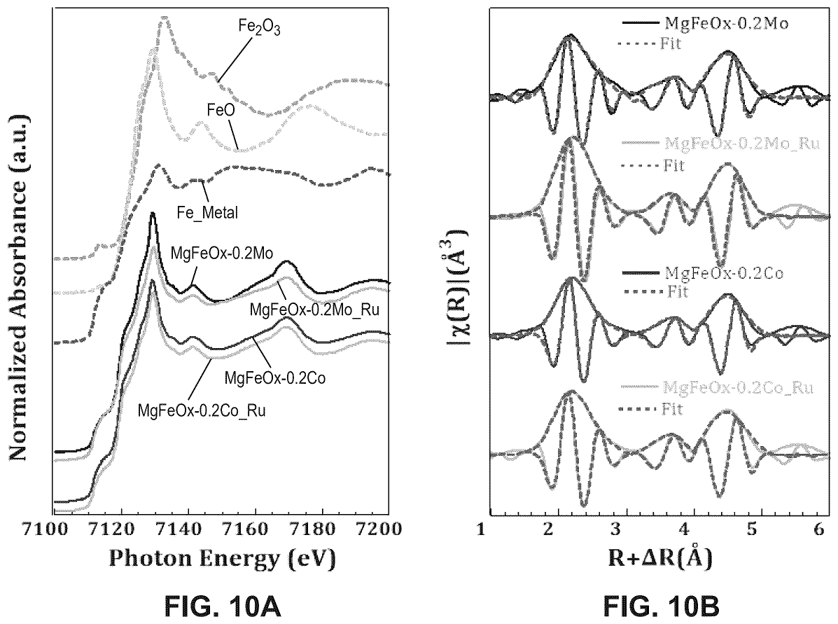

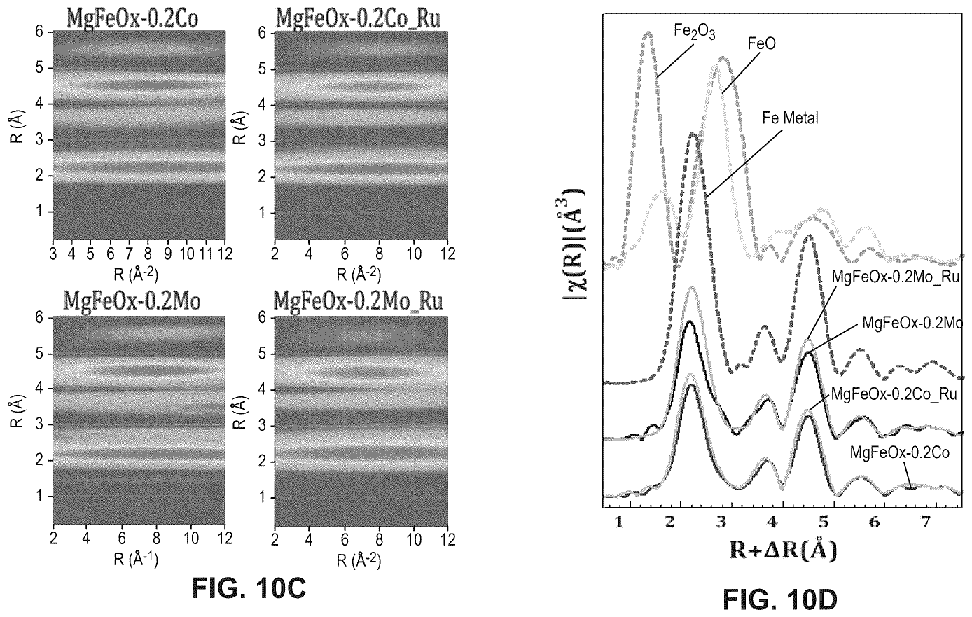

FIG. 10A illustrates normalized X-ray Absorption Near Edge Structure (XANES) data collected at Fe K-edge on various catalysts, along with Fe metal as a reference, according to some embodiments. FIG. 10A displays the XANES at the Fe K-edge of ex-situ reduced catalysts (under 10% H₂/Ar at 800° C.) and references FeO, Fe₂O₃, and Fe metal. In one example, the Fe K-edge XANES of all the catalysts present near-edge absorption energy between Fe metal and FeO reference values, indicating that the oxidation state of Fe sites is between Fe⁰ and Fe²⁺.

FIG. 10B illustrates Fourier transform (magnitude and real part) of the Extended X-ray Absorption Fine Structure (EXAFS) signal collected at the Fe K-edge on various catalysts together with the fitting models, according to some embodiments. FIG. 10C illustrates wavelet of the EXAFS signal showing the backscattering peaks as a function of the wave number, according to some embodiments. FIG. 10D illustrates the Fourier-transformed EXAFS signal compared to a reference, according to some embodiments. The coordination environment of Fe was investigated using the Fourier-transformed (FT) Fe K-edge EXAFS profiles of the bimetallic, monometallic catalysts, and Fe metal. In one example, the best-fitted EXAFS results for Fe in all the catalysts, along with Fe metal as a reference, indicate the presence of Fe—Fe bonds, with varying coordination numbers (CN) at nearly identical atomic distances, closely matching the fitting results for Fe metal (Table 3). In one example, this can suggest that the majority of the Fe present in these catalysts belongs to the Fe—Fe chemical environment.

TABLE 3
EXAFS results of Fe for MgFeOₓ—0.2Co, MgFeOₓ—0.2Co_Ru,
MgFeOₓ—0.2Mo and MgFeOₓ—0.2Mo_Ru catalysts along with Fe metal
as reference. N is the number of atoms, R is the distance, σ² is the
Debye-Waller factor, and ΔE₀ the offset from the threshold energy.

| Sample | Bond | CN (Atom) | R (Å) | σ²(Å2) | ΔE (eV) |
|---|---|---|---|---|---|
| MgFeOₓ—0.2Co | Fe—Fe | 10.0 ± 1.5 | 2.50 ± 0.02 | 0.006(1) | 1.1 ± 0.3 |
| | Fe—Fe | 4.3 ± 2.1 | 2.82 ± 0.04 | 0.010(7) | 1.3 ± 0.2 |
| | Fe—Fe | 15.6 ± 5.6 | 4.09 ± 0.02 | 0.011(3) | 1.2 ± 0.2 |
| | Fe—Fe | 46 ± 9.3 | 4.99 ± 0.01 | 0.011(3) | −4.2 ± 0.9 |
| MgFeOₓ—0.2Co_Ru | Fe—Fe | 10.4 ± 1.2 | 2.50 ± 0.03 | 0.006(01) | 1.9 ± 0.4 |
| | Fe—Fe | 3.9 ± 2.7 | 2.82 ± 0.06 | 0.009(6) | 1.3 ± 0.4 |
| | Fe—Fe | 13.5 ± 4.6 | 4.08 ± 0.02 | 0.010(3) | 1.0 ± 0.2 |
| | Fe—Fe | 52 ± 9.7 | 5.00 ± 0.09 | 1.010(1) | −4.1 ± 1.0 |
| MgFeOₓ—0.2Mo | Fe—Fe | 8.9 ± 0.6 | 2.47 ± 0.03 | 0.004(1) | 3.3 ± 0.2 |
| | Fe—Fe | 3.2 ± 0.7 | 2.85 ± 0.02 | 0.003(3) | 3.3 ± 0.1 |
| | Fe—Fe | 14.3 ± 4.5 | 4.28 ± 0.02 | 0.011(2) | −1.5 ± 0.2 |
| | Fe—Fe | 35.1 ± 6.2 | 5.00 ± 0.01 | 0.011(1) | −3.6 ± 1.1 |
| MgFeOₓ—0.2Mo_Ru | Fe—Fe | 9.0 ± 0.6 | 2.48 ± 0.01 | 0.003(1) | 4.9 ± 0.2 |
| | Fe—Fe | 4.3 ± 0.8 | 2.87 ± 0.02 | 0.002(4) | 3.2 ± 0.5 |
| | Fe—Fe | 12.6 ± 5.0 | 4.06 ± 0.02 | 0.010(3) | 4.3 ± 0.2 |
| | Fe—Fe | 32.9 ± 13.2 | 4.98 ± 0.03 | 0.007(4) | −4.9 ± 2.2 |
| Fe-metal (ref) | Fe—Fe | 12.0 | 2.475 | — | — |
| | Fe—Fe | 6.0 | 3.500 | | |
| | Fe—Fe | 24.0 | 4.287 | | |
| | Fe—Fe | 12.0 | 4.950 | | |

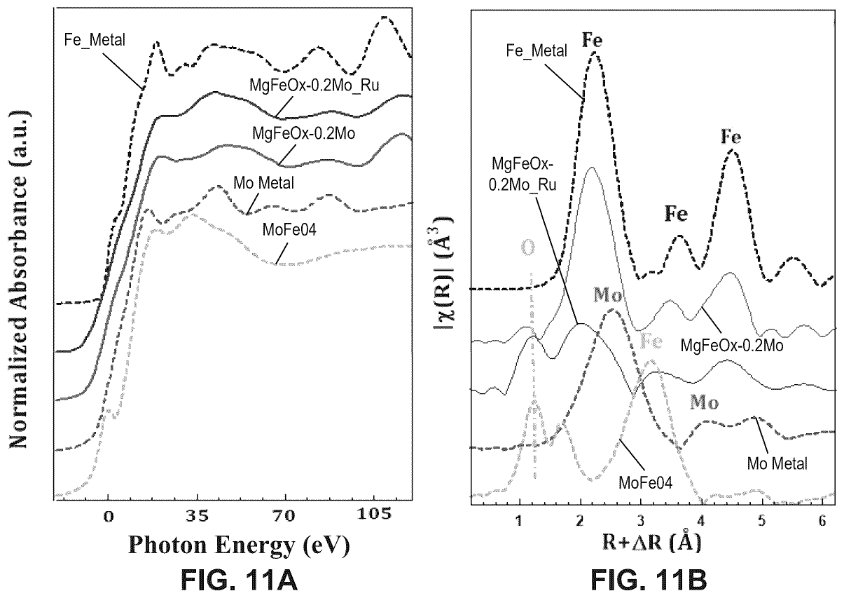

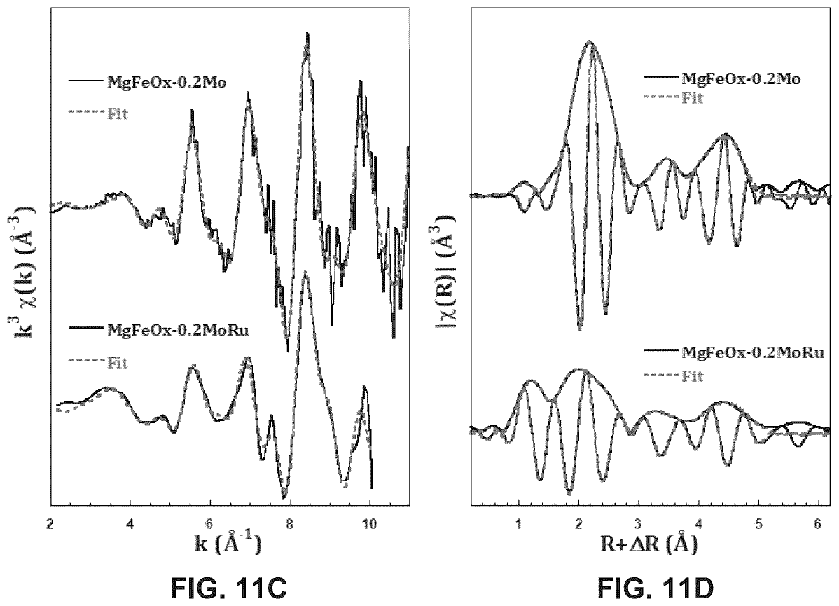

FIG. 11A illustrates XANES data collected at the Mo K-edge from a catalyst and references, according to some embodiments. The XANES spectra collected are at the K-edge of Mo for MgFeOₓ-0.2Mo and MgFeOₓ-0.2Mo_Ru catalysts along with Mo metal, Fe metal, and MoFeO₄ as comparisons. The normalized absorption XANES spectra are plotted as a function of E-E₀ (where E: scanned photon energy (eV) E₀: the binding energy of the electron from the 1s shell for Fe (7112) and Mo (20000) to allow comparison between Mo and Fe. In one example, in comparison to the spectra of Mo metal or MoFeO₄ reference, the spectra of the two catalysts (MgFeOₓ-0.2Mo, and MgFeOₓ-0.2Mo—Ru) are qualitatively similar to each other, and the spectra for Fe metal as reference.

First, this resemblance can suggest that Mo might be in a chemical environment where Fe is the primary influence, implying a strong contact or coordination with Fe atoms in the catalyst matrix. For example, additionally, the deviation from the spectra of Mo (metal environment) or MoFeO₄ (spinel environment) shows that Mo is not present in a purely metallic or fully oxidized form, but rather in a reduced state or partially substituted form within the Fe-dominated oxide structure. In one example, this similarity to Fe metal also can suggest important electronic or structural interactions between Mo and Fe, which may indicate that Mo is changing its electronic environment by either substituting into Fe sites or being coordinated by Fe atoms differently. In one example, these results can show that Mo is engaged in strong Fe-like bonding in the MgFeOₓ-0.2Mo and MgFeOₓ-0.2Mo_Ru catalysts forming the MoFe metallic/alloy phase.

FIG. 11B illustrates the FT of k³ weighted EXAFS signal collected on catalysis samples compared to references, according to some embodiments. FIG. 11C illustrates fitting the k³ weighted EXAFS data, according to some embodiments. FIG. 11D illustrates corresponding FT (magnitude and real-part) collected at the Mo K-edge (20 keV) on catalysts, according to some embodiments. EXAFS analysis was performed and FIG. 11B-11D display the FT of the k³-weighted EXAFS data for the MgFeOₓ-0.2Mo and MgFeOₓ-0.2Mo_Ru catalysts. For MgFeOₓ-0.2Mo and MgFeOₓ-0.2Mo_Ru, the EXAFS-derived structural parameters revealed a peak at ˜1.61 Å (Table 4), attributed to oxygen in the first coordination shell corresponding to MoO₃.

However, the analysis indicated that oxygen is not the predominant coordination environment for Mo atoms, with coordination numbers of 0.3 and 1 for MgFeOₓ-0.2Mo and MgFeOₓ-0.2Mo_Ru, respectively. This can suggest that only a small fraction of Mo atoms are surrounded by oxygen. In one example, in MgFeOₓ-0.2Mo, Mo atoms exhibited an average coordination number of 8.4 and a mean bond length of 2.50 Å to surrounding Fe atoms, which is shorter than the first Mo—Mo coordination shell in bulk Mo metal (2.72 Å). For example, no Mo—Mo scattering was detected, showing that the Mo atoms were predominantly isolated and coordinated with Fe.

TABLE 4
EXAFS results of Mo for MgFeOₓ—0.2Mo and MgFeOₓ—0.2Mo_Ru
catalysts and Mo and Fe metal as references.

| Sample | Bond | N (atom) | R (Å) | σ²(Å2) | ΔE (eV) |
|---|---|---|---|---|---|
| MgFeOₓ—0.2Mo | Mo—O | 0.3 ± 0.03 | 1.61 ± 0.05 | 0.003(6) | −3.7 ± 2.2 |
| | Mo—Fe | 8.4 ± 2.7 | 2.50 ± 0.02 | 0.006(2) | 4.3 ± 0.7♦ |
| | Mo—Fe | 8.6 ± 0.5 | 2.85 ± 0.01 | 0.007(5) | 4.3 ± 0.7♦ |
| | Mo—Fe | 4.1 ± 0.5 | 3.54 ± 0.04 | 0.009(8) | 4.3 ± 0.7♦ |
| | Mo—Fe | 0.5 ± 0.2 | 3.83 ± 0.02 | 0.010(9) | 4.3 ± 0.7♦ |
| | Mo—Fe | 11.9 ± 1.1 | 4.43 ± 0.05 | 0.010(7) | 4.3 ± 0.7♦ |
| | Mo—Fe | 23.6 ± 3.4 | 5.02 ± 0.04 | 0.010(7) | −4.5 ± 0.3 |
| MgFeOₓ—0.2Mo_Ru | Mo—O | 1.0 ± 0.1 | 1.69 ± 0.03 | 0.009(1) | 4.0 ± 0.8 |
| | Mo—Fe | 3.4 ± 1.8 | 2.45 ± 0.01 | 0.005(4) | −4.6 ± 0.6 |
| | Mo—Fe | 7.2 ± 2.5 | 2.86 ± 0.01 | 0.005(8) | −2.8 ± 0.4 |
| | Mo—Ru | 0.6 ± 0.1 | 3.67 ± 0.01 | 0.009(4) | −1.2 ± 0.1 |
| | Mo—Fe | 4.9 ± 2.3 | 4.45 ± 0.05 | 0.009(3) | 2.1 ± 1.0 |
| | Mo—Fe | 12.7 ± 3.1 | 5.10 ± 0.05 | 0.003(8) | −2.6 ± 0.4 |
| Mo Metal | Mo—Mo | 8.0 | 2.725 | | |
| | Mo—Mo | 6.0 | 3.147 | | |
| | Mo—Mo | 12.0 | 4.450 | | |
| | Mo—Mo | 24.0 | 5.218 | | |
| Fe-Metal | Fe—Fe | 12.0 | 2.475 | | |
| | Fe—Fe | 6.0 | 3.500 | | |
| | Fe—Fe | 24.0 | 4.287 | | |
| | Fe—Fe | 12.0 | 4.950 | | |
| MoFeO₄ | Mo—O | 12.0 | 1.79 | | |
| | Mo—Fe | 6.0 | 1.84 | | |
| | Mo—O | 20.0 | 2.02 | | |
| | Mo— | 4.0 | 2.13 | | |
| | Mo/Fe | 6.0 | 3.01 | | |
| | Mo— | | | | |
| | Mo/Fe | | | | |

The Mo—Fe bond length of 2.50 Å was consistent with the Fe K-edge EXAFS fitting, which yielded a value of 2.47 Å (FIG. 11D), closely resembling the Fe—Fe bond length in the bcc Fe lattice. This alignment can suggest that the incorporation of Mo into the Fe lattice is influenced by the confinement effects of the structure. A peak at R=2.45 Å is attributed to the Fe—Mo bond in a tandem structure. This was also observed upon the incorporation of Ru in the MgFeOₓ-0.2Mo_Ru catalyst with a peak at R=2.45 Å corresponding to the Mo—Fe bond. In addition, a Mo—Ru bond was observed with R=3.6 Å a small number of atoms (CN=0.6), indicating few Mo atoms involved in bonding with Ru. In one example, the findings derived from XANES and EXAFS analysis show the formation of a MoFe solid solution rather than the presence of isolated Mo metal clusters.

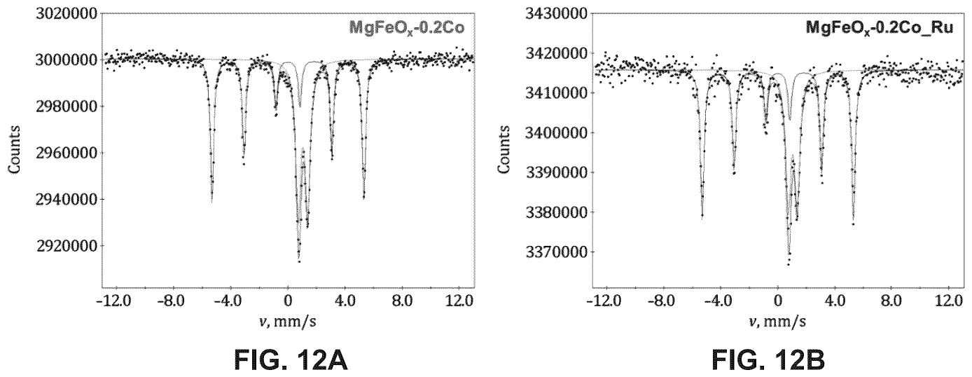

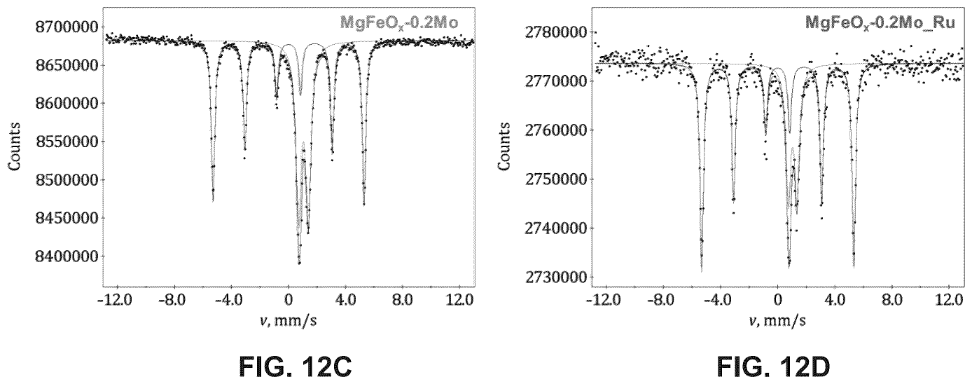

FIG. 12A illustrates a Mossbauer spectrum of a catalyst (MgFeOₓ-0.2Co), according to some embodiments. FIG. 12B illustrates a Mossbauer spectrum of a catalyst (MgFeOₓ-0.2Co_Ru), according to some embodiments. FIG. 12C illustrates a Mossbauer spectrum of a catalyst (MgFeOₓ-0.2Mo), according to some embodiments. FIG. 12D illustrates a Mossbauer spectrum of a catalyst (MgFeOₓ-0.2Mo_Ru), according to some embodiments.

The ⁵⁷Fe Mössbauer spectra were recorded at room temperature on the reduced (800° C. under 10% H₂ atmosphere for 1h) MgFeOₓ support, as well as MgFeOₓ-0.2Co, MgFeOₓ-0.2Co_Ru, MgFeOₓ-0.2Mo, and MgFeOₓ-0.2Mo_Ru catalysts. The values of the Mössbauer hyperfine parameters, derived from the spectra fitting, are listed in Table 5. Across all samples, the sextet (δ≈ 0.00 mm/s) corresponds to Fe⁰, indicating the presence of metallic iron, while the doublet (δ≈ 1.03-1.05 mm/s, ΔE_{Q}≈0.59-0.68 mm/s) represents Fe²⁺, associated with Fe in the MgFeOₓ matrix. In one example, the RA (relative area) values show significant differences in Fe⁰ and Fe²⁺ proportions between the different samples.

TABLE 5
Values of the Mössbauer hyperfine parameters, derived from the
least-square fitting of the Mössbauer spectra, where T is the temperature
of the measurement, δ is the isomer shift, ΔE_{Q} is the quadrupole splitting,
B_{hf} is the hyperfine magnetic field, and RA is the relative spectral area
of individual spectral components identified during fitting.

| | | | δ ± | ΔE_{Q} ± | B_{hf} ± | RA ± | |
|---|---|---|---|---|---|---|---|
| | T | | 0.01 | 0.01 | 0.3 | 1 | Fe |
| Support/Catalyst | (K) | Component | (mm/s) | (mm/s) | (T) | (%) | Speciation |
| MgFeOₓ | 300 | Sextet | 0.00 | 0.00 | 32.34 | 60.7 | Fe⁰ |
| | | Doublet | 1.03 | 0.63 | — | 39.3 | Fe²⁺ |
| MgFeOₓ—0.2Co | 300 | Sextet | 0.00 | 0.01 | 33.05 | 56.3 | Fe⁰ |
| | | Doublet | 1.05 | 0.66 | — | 43.7 | Fe²⁺ |
| MgFeOₓ—0.2Co_Ru | 300 | Sextet | 0.00 | 0.00 | 32.97 | 61.6 | Fe⁰ |
| | | Doublet | 1.04 | 0.63 | — | 38.4 | Fe²⁺ |
| MgFeOₓ—0.2Mo | 300 | Sextet | 0.00 | 0.01 | 32.90 | 55.9 | Fe⁰ |
| | | Doublet | 1.05 | 0.68 | — | 44.1 | Fe²⁺ |
| MgFeOₓ—0.2Mo_Ru | 300 | Sextet | 0.00 | 0.01 | 33.06 | 69.5 | Fe⁰ |
| | | Doublet | 1.04 | 0.59 | — | 30.5 | Fe²⁺ |

In the MgFeOₓ support, Fe⁰ contributes 60.7%, while Fe²⁺ accounts for 39.3%. The Mössbauer spectroscopy results further indicate that the Fe oxidation states vary depending on the presence of Mo, Co, and Ru in the MgFeOₓ-based catalysts. Specifically, a higher fraction of Fe metallic (Fe⁰) is observed following the trend: MgFeOₓ<MgFeOₓ-0.2Co_Ru<MgFeOₓ-0.2Mo_Ru, whereas in MgFeOₓ-0.2Mo and MgFeOₓ-0.2Co, Fe²⁺ and Fe⁰ exist in nearly equal atomic composition (˜50% each). This difference can be attributed to the oxophilicity of Mo and Co, which influences Fe oxidation states. The oxophilic nature (affinity to oxygen) of these metals leads to oxygen retention in the lattice. In one example, this stabilization effect can prevent the complete reduction of Fe³⁺ to Fe⁰, instead favoring the formation of Fe^{2+.}

However, the introduction of Ru significantly enhances Fe⁰ content, in the bimetallic systems, namely MgFeOₓ-0.2Co_Ru and MgFeOₓ-0.2Mo_Ru catalysts, where Fe⁰ reaches 61.6 and 69.5%, respectively. This enhancement is primarily due to Ru's ability to facilitate hydrogen dissociation, which is subsequently followed by atomic hydrogen species spillover to the support and, thus, promotion of the Fe³⁺→Fe²⁺→Fe⁰ reduction. In one example, Ru reduces the impact of Mo and Co on oxophilicity by creating an environment more conducive to Fe reduction, thereby increasing the overall Fe⁰ fraction.

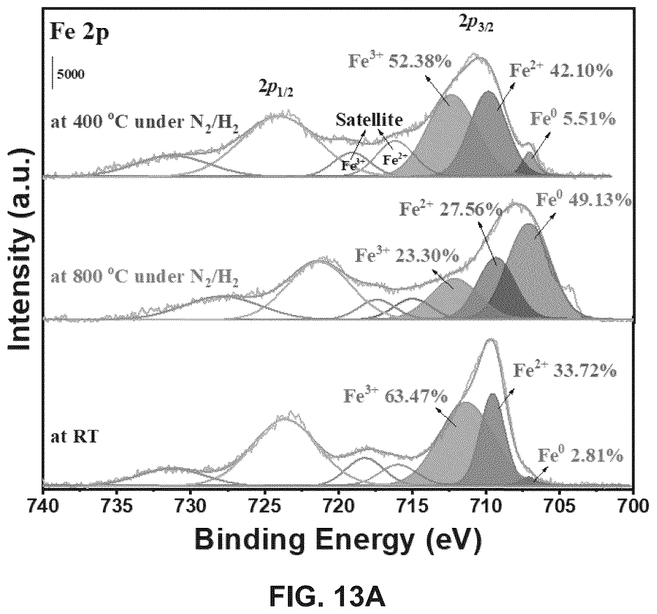

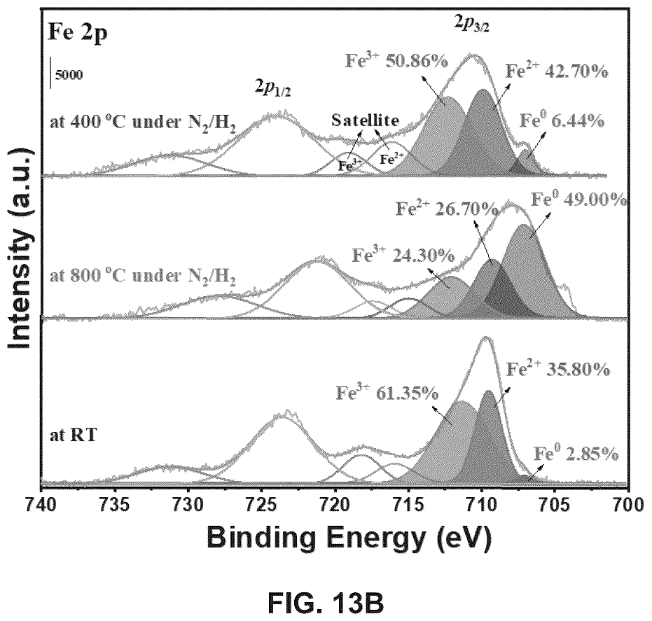

FIG. 13A illustrates XPS spectra of Fe 2p for a catalyst (MgFeOₓ-0.2Co—Ru) at various temperatures under N₂/H₂ environment, according to some embodiments. FIG. 13B illustrates XPS spectra of Fe 2p for a catalyst (MgFeOₓ-0.2Mo—Ru) at various temperatures under N₂/H₂ environment, according to some embodiments. The analysis was conducted under three distinct temperature conditions to evaluate the behavior of the MgFeOₓ-supported catalysts. Initially, at RT under atmospheric conditions, baseline measurements were obtained to establish reference data. Subsequently, an in-situ reduction was performed by heating the catalysts up to 800° C. with a linear ramp of 10° C./min in a reducing atmosphere including H₂/N₂ in a 3:1 ratio. This high-temperature treatment facilitates the reduction of catalysts and potential restructuring of the catalyst surface as it was observed from in-situ XRD analysis of MgFeOₓ-0.2Co—Ru and XAFS analysis of MgFeOₓ-0.2Mo—Ru. Finally, the system was subjected to in-situ reaction conditions at 400° C., maintaining the same H₂/N₂ (3:1) environment.

The spectra were internally calibrated using the C Is peak of the samples with a fixed value of 284.8 eV. After calibration, the background from each spectrum was subtracted using a Shirley-type background to remove most of the extrinsic loss structure. The Fe 2p spectrum at RT shows the peaks situated at 709.5 eV belong to bivalent iron (Fe²⁺), and the peaks at 711.3 eV are attributed to trivalent iron (Fe³), while the peak at 706.9 eV is assigned to metallic iron (Fe⁰). As the temperature increases to 800° C., a shift in BE was observed towards higher BE (ABE). The ABE is attributed to the decreasing electron density of the Fe atom under reduction conditions (800° C. under N₂/H₂), which is maintained under reaction conditions (400° C. under N₂/H₂).

In one example, at RT, Fe is predominantly in the Fe³⁺ oxidation state, indicating a more oxidized form in the absence of reducing conditions. At 800° C., there is an increase in metallic Fe⁰ content, with Fe³⁺ and Fe²⁺ present in approximately equal concentrations. In one example, upon reducing the temperature to 400° C., Fe²⁺ and Fe³⁺ remain in nearly equal amounts, but their combined percentage surpasses Fe⁰. For example, MgFeOₓ-based bimetallic catalysts, when reduced, form significant amounts of Fe⁰.

From the atomic % shown in Table 6, it was observed that Co tends to preferentially localize at the surface of the MgFeOₓ support. In one example, this surface segregation is primarily driven by differences in surface energies between the host (MgFeOₓ) and solute (Co) lattices. Co has lower surface energy compared to Fe and Mg in the MgFeOₓ matrix, making it thermodynamically favorable for Co atoms to migrate to the surface to minimize the system's overall energy. In one example, these factors collectively influence the tendency of certain elements, like Co, to migrate towards the surface in alloy systems. The XPS peak areas for Mo and Ru decrease at higher temperatures, which can be due to surface migration or partial volatilization.

TABLE 6
Atomic ratio % on surface by XPS for MgFeOₓ—0.2x_y
catalysts, x = Co or Mo, y = Ru.
MgFeOₓ—0.2Co_Ru

| Atomic % | O | Mg | Fe | Co | Ru |
|---|---|---|---|---|---|
| At RT | 62.44 | 30.34 | 6.69 | 0.39 | 0.14 |
| 800° C. | 49.89 | 44.24 | 5.49 | 0.33 | 0.05 |
| 400° C. | 52.82 | 41.44 | 5.40 | 0.30 | 0.04 |

MgFeOₓ—0.2Mo_Ru

| Atomic % | O | Mg | Fe | Mo | Ru |
|---|---|---|---|---|---|
| At RT | 60.97 | 33.83 | 4.96 | 0.06 | 0.20 |
| 800° C. | 49.06 | 45.21 | 5.63 | 0.07 | 0.04 |
| 400° C. | 49.30 | 45.49 | 5.12 | 0.05 | 0.04 |

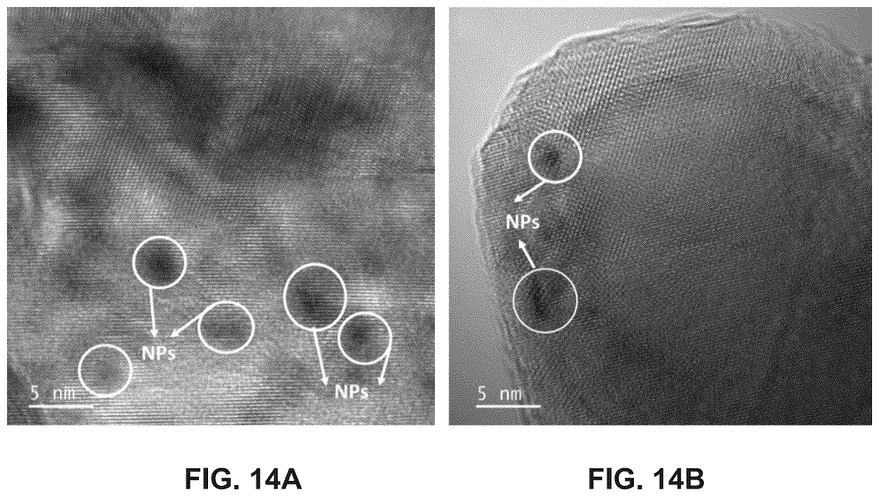

FIG. 14A illustrates an High-Resolution Transmission Electron Microscopy (HR-TEM) image of a catalyst (MgFeOₓ-0.2Co_Ru) after in-situ reduction at 800° C. under N₂/H₂=⅓ atmosphere, according to some embodiments. FIG. 14B illustrates an HR-TEM image of a catalyst (MgFeOₓ-0.2Mo_Ru) after in-situ reduction at 800° C. under N₂/H₂=⅓ atmosphere, according to some embodiments. In one example, HRTEM images reveal the structural and morphological characteristics of nanoparticles (NPs) supported on a reduced MgFeOₓ-based bimetallic catalysts. In one example, Ru-containing alloyed nanoparticles with possible Fe—Mo—Ru or Fe—Co—Ru compositions present in the catalysts were observed to be of ˜3.5-4 nm size. For example, homogenous distribution of Co, Ru, and Mo, Ru was observed for the two bimetallic catalysts. Also, the metal pairs (Fe/Co, Fe/Mo) were observed to have the tendency to be located close to each other.

In one example, Mg and O were found in the same areas (reside in the vicinity), while Fe metallic resides close to Co/Ru or Mo/Ru. This finding aligns with the phase transformation of MgFeOₓ-supported catalysts towards the formation of FeCo or FeMo alloyed phases after the applied reduction conditions, as noticed from the in-situ XRD and the ex-situ XRD studies over the reduced catalysts. In one example, STEM-EDS analysis revealed that larger metallic particles exhibit a homogeneous distribution of both Fe and Co, indicative of bimetallic alloy formation. In one example, the surrounding smaller particles were predominantly Mg and O, with minor incorporations of Fe and Co, suggesting the formation of a wüstite-like Mg(Fe,Co) O phase.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A catalyst, comprising:
a MgFeOₓ support, wherein x is a number of oxygen atoms present;
ruthenium in contact with at least a portion of the MgFeOₓ support; and
an additive including at least one of cobalt and molybdenum, where a weight ratio of the ruthenium to the additive ranges from about 1:5 to about 5:1.

2. The catalyst of claim 1, wherein the MgFeOₓ support is prepared from MgFe layered double hydroxide (LDH).

3. The catalyst of claim 1, wherein an amount of ruthenium present in the catalyst ranges from about 0.05 wt. % to about 1.0 wt. %.

4. The catalyst of claim 1, wherein an atomic ratio of Mg to Fe is about 2:1, and wherein x is equal to 4.

5. The catalyst of claim 1, wherein the additive includes cobalt.

6. The catalyst of claim 5, wherein a weight percentage of cobalt in the catalyst ranges from about 0.05 wt. % to about 2 wt. %.

7. The catalyst of claim 5, wherein a weight percentage of cobalt in the catalyst ranges from about 0.05 wt. % to about 0.3 wt. %, and wherein an amount of ruthenium present in the catalyst ranges from about 0.05 wt. % to about 0.3 wt. %.

8. The catalyst of claim 1, wherein the additive includes molybdenum.

9. The catalyst of claim 8, wherein a weight percentage of molybdenum in the catalyst ranges from about 0.05 wt. % to about 2 wt. %.

10. A catalyst for ammonia synthesis, comprising:
a magnesium-containing support;
ruthenium in contact with at least a portion of the magnesium-containing support, wherein a weight percentage of ruthenium in the catalyst ranges from about 0.05 wt. % to about 1 wt. %; and
cobalt, wherein a weight percentage of cobalt in the catalyst ranges from about 0.05 wt. % to about 1 wt. %.

11. The catalyst of claim 10, wherein the magnesium-containing support includes a MgFeOₓ support prepared from MgFe layered double hydroxide (LDH).

12. The catalyst of claim 10, wherein an amount of ruthenium present in the catalyst ranges from about 0.05 wt. % to about 0.2 wt. %.

13. The catalyst of claim 10, wherein the catalyst exhibits an average pore size ranging from about 20 nm to about 40 nm, a pore volume ranging from about 0.1 cm³/g to about 0.4 cm³/g, and a surface area ranging from 20 m²/g to 50 m²/g.

14. A method for ammonia synthesis, comprising:
introducing a nitrogen-containing feed stream to a catalyst sufficient to form ammonia at a process temperature,
wherein the catalyst includes:
a MgFeOₓ support, wherein x is a number of oxygen atoms present;
ruthenium in contact with at least a portion of the MgFeOₓ support; and
an additive including at least one of cobalt and molybdenum.

15. The method of claim 14, wherein the nitrogen-containing feed stream further includes at least one of hydrogen, water, and natural gas.

16. The method of claim 14, wherein an amount of ruthenium present in the catalyst ranges from about 0.05 wt. % to about 1.0 wt. %.

17. The method of claim 14, wherein the additive includes cobalt, wherein a weight percentage of cobalt in the catalyst ranges from about 0.05 wt. % to about 2 wt. %.

18. The method of claim 17, wherein the weight percentage of cobalt in the catalyst ranges from about 0.05 wt. % to about 0.3 wt. %.

19. The method of claim 14, wherein the additive includes molybdenum, wherein a weight percentage of molybdenum in the catalyst ranges from about 0.05 wt. % to about 2 wt. %.

20. The method of claim 14, wherein the process temperature ranges from about 350° C. to about 450° C.
